(19) United States
(12) Patent Application Publication
(10) Pub. No.: US 2006/0020935 A1
(43) Pub. Date: Jan. 26, 2006

(54) Scheduler for dynamic code reconfiguration

(76) Inventors: Sang Van Tran, Encinitas, CA (US); Kenneth L. Welch, Alpine, CA (US)

Correspondence Address: MCANDREWS HELD & MALLOY, LTD, 500 WEST MADISON STREET, SUITE 3400, CHICAGO, IL, 60661, US

(21) Appl. No.: 10/884,708

(22) Filed: Jul. 2, 2004

(51) Int. Cl. G06F 9/44

(52) U.S. Cl. 717/162; 717/143

(57) ABSTRACT

A system and method for decoding data (e.g., decoding audio data in an audio decoder) utilizing dynamic code reconfiguration. Various aspects of the present invention may comprise identifying a data frame to process. Such identification may, for example, comprise selecting a data frame from a plurality of input channels. A processing task may be selected from a plurality of processing tasks. Such a processing task may, for example, comprise data parsing, decoding, combined parsing and decoding, and a variety of other tasks. Software instructions corresponding to the selected processing task may be identified and loaded from a first memory module into a local memory module and executed to process the identified data frame. The first memory module may, for example, comprise memory external to a signal-processing module, and the local memory module may, for example, comprise memory internal to the signal-processing module.

### CROSS-REFERENCE TO RELATED APPLICATIONS/INCORPORATION BY REFERENCE

This patent application is related to U.S. patent application Ser. No. 10/850,266, filed on May 20, 2004, entitled, DYNAMIC MEMORY RECONFIGURATION FOR SIGNAL PROCESSING (attorney docket No. 15492US01).

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

In signal processing systems (e.g., real-time digital signal processing systems), processing time constraints are often strict. For example, in a real time audio decoding system, the system must often perform audio decoding processing at a rate at least as fast as the rate at which the encoded audio information is arriving at the system.

In a signal processing system that includes a processor, such as a digital signal processor, executing software or firmware instructions, the rate at which the processor can execute the software instructions may be limited by the time that it takes the processor to retrieve the software instructions from memory and otherwise exchange data with memory. Processors may generally interact with different types of memory at different rates. The types of memory with which a processor may interface quickly are often the most expensive types of memory.

Further, a signal processing system may receive different types of signals with different respective processing needs. For example, a signal processing system may receive signals on a plurality of channels. Various systems may process signals from different channels in parallel, which may require redundant and costly signal processing circuitry and/or software.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for decoding data (e.g., decoding audio data in an audio decoder) utilizing dynamic code reconfiguration. Various aspects of the present invention may comprise identifying a data frame to process. Such identification may, for example, comprise selecting a data frame from an input channel of a plurality of input channels.

A processing task may be selected from a plurality of processing tasks. The plurality of processing tasks may, for example, comprise a parsing processing task that parses an input data frame and outputs information of the parsed input data frame to an output buffer. The plurality of processing tasks may also, for example, comprise a decoding processing task that decodes or decompresses an input data frame and outputs information of the decoded input data frame to an output buffer. The plurality of processing tasks may further, for example, comprise a combined parsing and decoding processing task that combines performance of the parsing processing task and the decoding processing task, and outputs information of the parsed input data frame and the decoded input data frame to respective output buffers.

A software module corresponding to the selected processing task may be identified and loaded from a first memory module into a local memory module and executed by a local processor to process the identified data frame. A selected processing task may, for example, correspond to a plurality of independent software modules that may be loaded and executed sequentially by the local processor to process the identified data frame.

A second input data frame, from the input channel or a second input channel may be identified, and various aspects mentioned above may be repeated to process the second identified input data frame.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a flow diagram showing an exemplary method for decoding data utilizing dynamic code reconfiguration, in accordance with various aspects of the present invention.

FIGS. 2A-2C are a flow diagram showing an exemplary method for decoding data utilizing dynamic code reconfiguration, in accordance with various aspects of the present invention.

FIG. 3 is a diagram showing an exemplary system for decoding data utilizing dynamic code reconfiguration, in accordance with various aspects of the present invention.

### DETAILED DESCRIPTION OF THE INVENTION

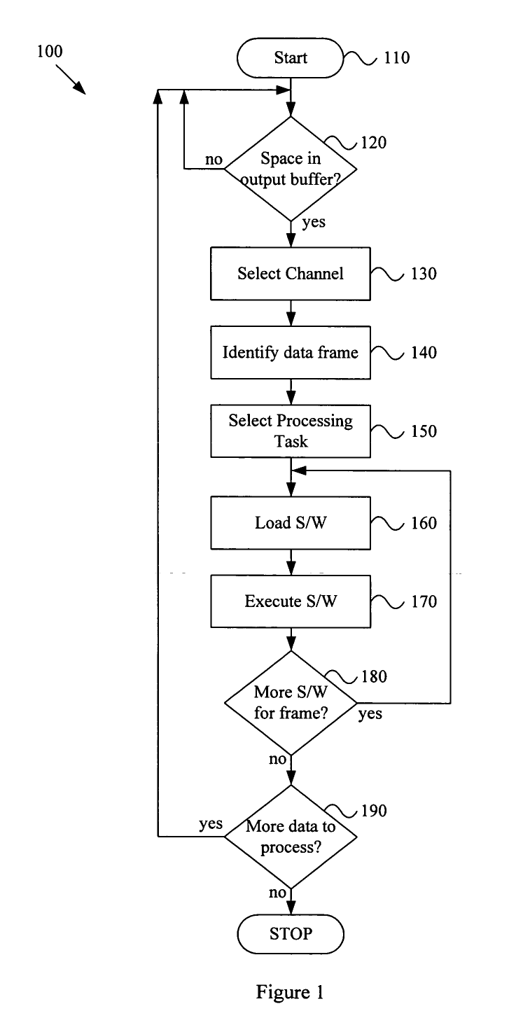

FIG. 1 is a flow diagram showing an exemplary method 100 for decoding data utilizing dynamic code reconfiguration, in accordance with various aspects of the present invention. The method 100 begins at step 110. Various events and conditions may cause the method 100 to begin. For example, a signal may arrive at a decoding system for processing. For example, in an exemplary audio decoding scenario, an encoded audio signal may arrive at an audio decoder for decoding. Generally, the method 100 may be initiated for a variety of reasons. Accordingly, the scope of various aspects of the present invention should not be limited by characteristics of particular initiating events or conditions.

The method 100, at step 120, determines whether there is space available in one or more output buffers for processed information. If step 120 determines that there is no output buffer space, step 120 may, for example, wait for output buffer space to become available. Output buffer space may become available, for example, by a downstream device reading data out from an output buffer. If step 120 determines that there is output buffer space available for additional processed information, the method 100 flow may continue to step 130.

The method 100, at step 130, may select a channel over which to receive data to decode (or otherwise process). For example, in an exemplary scenario, a signal decoding system may comprise a plurality of input channels over which to receive encoded data. Step 130 may, for example, select between such a plurality of input channels. Note that each of the plurality of input channels may, for example, communicate information that is encoded by any of a variety of encoding types.

For example and without limitation, in selecting between a plurality of input channels, step 130 may comprise utilizing a prioritized list of input channels to service. For example, step 130 may comprise reading such a prioritized list from memory or may comprise building such a prioritized list in real-time. Step 130 may, for example, cycle through a prioritized list until an input channel is located that has a frame of data to decode.

Such a prioritized list may be determined based on a large variety of criteria. For example, a prioritized list may be based on availability of output buffer space corresponding to a particular channel. Also, for example, a prioritized list may be based on the availability of input data in an input buffer (or channel). Further, for example, a prioritized list may be based on input data stream rate, the amount of processing required to process particular input data, first come first serve, earliest deadline first, etc. In general, channel priority may be based on any of a large variety of criteria, and accordingly, the scope of various aspects of the present invention should not be limited by characteristics of a particular type of prioritization or way of determining priority.

The method 100, at step 140, may comprise identifying a data frame to decode. For example, in a multi-channel scenario such as that discussed previously, after selecting a particular channel at step 130, step 140 may identify a data frame within the selected channel to decode. Such identification may, for example, comprise identifying a location in an input buffer at which the next data frame for a particular input channel resides. Such identification may also, for example, comprise determining various other aspects of the identified data frame (e.g., content data characteristics, starting point, ending point, length, etc.). In an exemplary audio scenario, step 140 may comprise identifying a next audio frame to decode in an audio system.

The method, at step 150, may comprise selecting a processing task to perform on the identified data frame. For example, step 150 may comprise selecting a processing task from a plurality of processing tasks. Step 150 may comprise selecting a processing task based on a real-time analysis of information arriving on the selected channel or may, for example, select a processing task based on stored configuration information correlating a processing task with a particular input channel.

In an exemplary signal decoder scenario, a plurality of processing tasks may comprise a parsing processing task, a decoding processing task and/or a combined parsing and decoding processing task. An exemplary parsing processing task may parse the identified data frame (e.g., an encoded audio data frame) and output information of the parsed data frame to an output buffer in memory. Such information of the parsed data frame may, for example, comprise the same compressed data with which the identified data frame arrived and may also comprise status information determined by the parsing processing task. For example, the parsing processing task may output information of the parsed data frame in compressed Pulse Code Modulation (“PCM”) (or non-linear PCM) format. The following discussion may refer to executing the parsing processing task as the “simple mode.”

An exemplary decoding processing task may decode the identified data frame (e.g., an encoded audio data frame) and output information of the decoded data frame to an output buffer in memory. Such information of the decoded data frame may, for example, comprise decoded (or decompressed) data that corresponds to the encoded (or compressed) information with which the identified data frame arrived. For example, the decoding processing task may output information of the decoded data frame in uncompressed PCM (or linear PCM) format. The following discussion may refer to executing the decoding processing task as the “complex mode.”

The decoding processing task is not necessarily limited to performing a standard decoding task. For example and without limitation, in an exemplary audio decoding scenario, the decoding processing task may perform MPEG layer 1, 2 or 3, AC3, or MPEG-2 AAC decoding with associated post-processing. The decoding processing task may, for example, also comprise performing high fidelity sampling rate conversion, decoding LPCM, etc. Accordingly, the scope of various aspects of the present invention should not be limited by characteristics of a particular decoding processing task or sub-task, or by characteristics of other related processing tasks.

An exemplary combined parsing and decoding processing task may perform each of the parsing and decoding processing tasks discussed previously. For example and without limitation, the combined parsing and decoding processing task may output information of the parsed data frame and information of the decoded data frame to respective output buffers in memory. For example, the combined parsing and decoding processing task may output information in both linear and non-linear PCM format. In an exemplary scenario, the combined parsing and decoding processing task may output information of the same input data stream with the same PID in both linear PCM and non-linear PCM formats. The following discussion may refer to executing the combined parsing and decoding processing task as the “simultaneous mode.”

Note that the previously discussed exemplary scenario involving the simple, complex and simultaneous modes and associated processing tasks are merely exemplary. In general, step 150 may comprise selecting a processing task from a plurality of processing tasks. Accordingly, the scope of various aspects of the present invention should not be limited by characteristics of a particular processing task or group of processing tasks.

The method 100, at step 160, may comprise loading software instructions corresponding to the selected processing task into local memory (e.g., a local memory module) of a processor. In an exemplary scenario, such software instructions may be initially stored in a first memory module that resides on a different integrated circuit chip than the processor. For example and without limitation, such software instructions may reside on external DRAM or SDRAM, and a processor may load such software instructions into internal SRAM. The processor may, for example, utilize a look-up table to determine where software instructions corresponding to the selected processing task are located.

In general, step 160 may comprise loading software instructions corresponding to the selected processing task into local memory of a processor. Accordingly, the scope of various aspects of the present invention should not be limited by characteristics of particular software, characteristics of particular software storage, or characteristics of a particular software loading process.

The method, at step 170, may comprise executing the software instructions loaded at step 160. A processor may execute the loaded software instructions to partially or completely process all or a portion of the data frame identified at step 140.

The software instructions corresponding to the selected processing task may, for example, reside in independent software modules, which may be independently loaded and executed. For example, a particular decoding task for a particular encoding style may comprise a series of software modules that may be loaded and executed sequentially to accomplish the selected processing task. For example and without limitation, a particular decoding processing task may comprise a main decoding software module and a post-processing software module.

The method, at step 180, may determine whether there is additional software to execute to accomplish the selected processing task on the identified data frame. If step 180 determines that there is an additional software module(s) to execute to accomplish the selected processing task, then the method 100 flow may, for example, loop back to step 160 to load the additional software module, which may then be executed at step 170 to further process the identified data frame.

The method, at step 190, may determine whether there is additional data to process. For example, the input channel selected at step 130 (or an input buffer corresponding thereto) may comprise additional data frames to process. Also, for example, other input channels may comprise data frames to process.

If step 190 determines that there is additional data to process, the method 100 flow may loop back to step 120 to ensure there is adequate space in an output buffer for the data resulting from further processing. If step 190 determines that there is no additional data to process, the method 100 flow may, for example, stop executing or may continue to actively monitor output and input buffers to determine whether to process additional data.

It should be noted that the method 100 illustrated in FIG. 1 is exemplary. The scope of various aspects of the present invention should by no means be limited by particular details of specific illustrative steps discussed previously, by the particular illustrative step execution order, or by the existence or non-existence of particular steps.

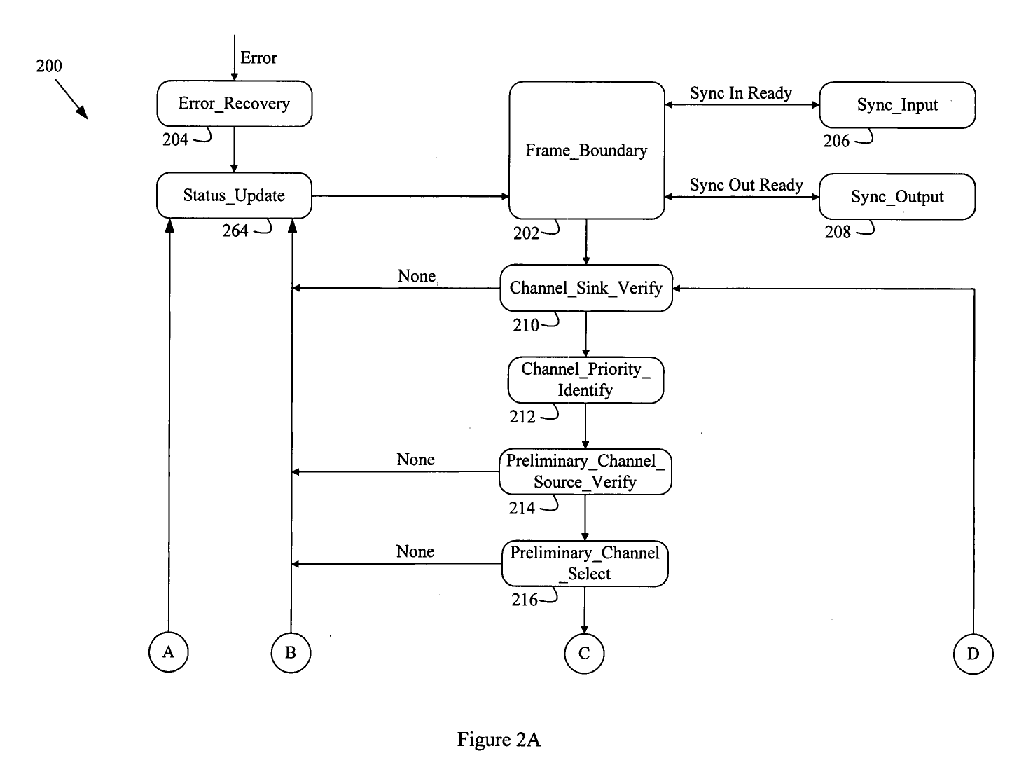

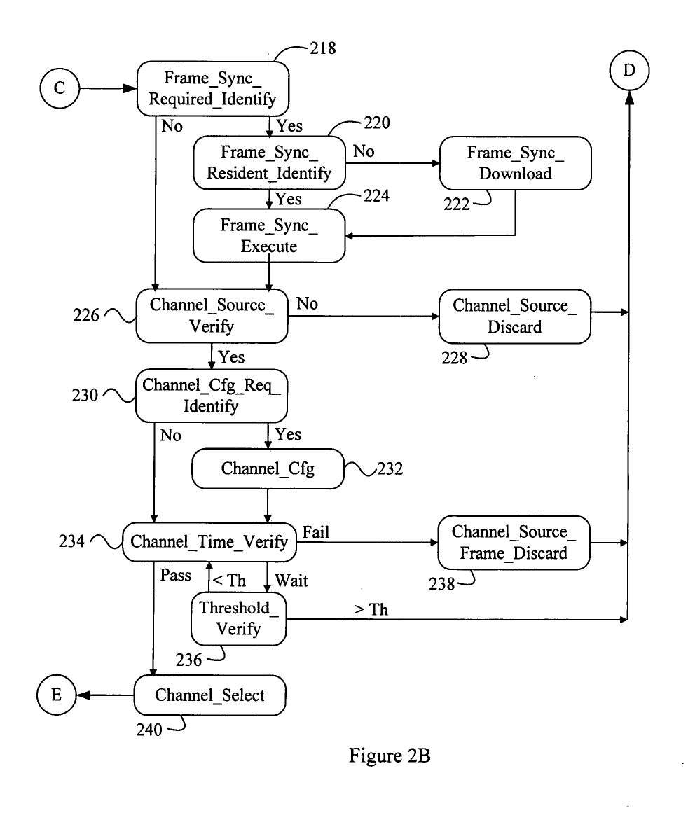

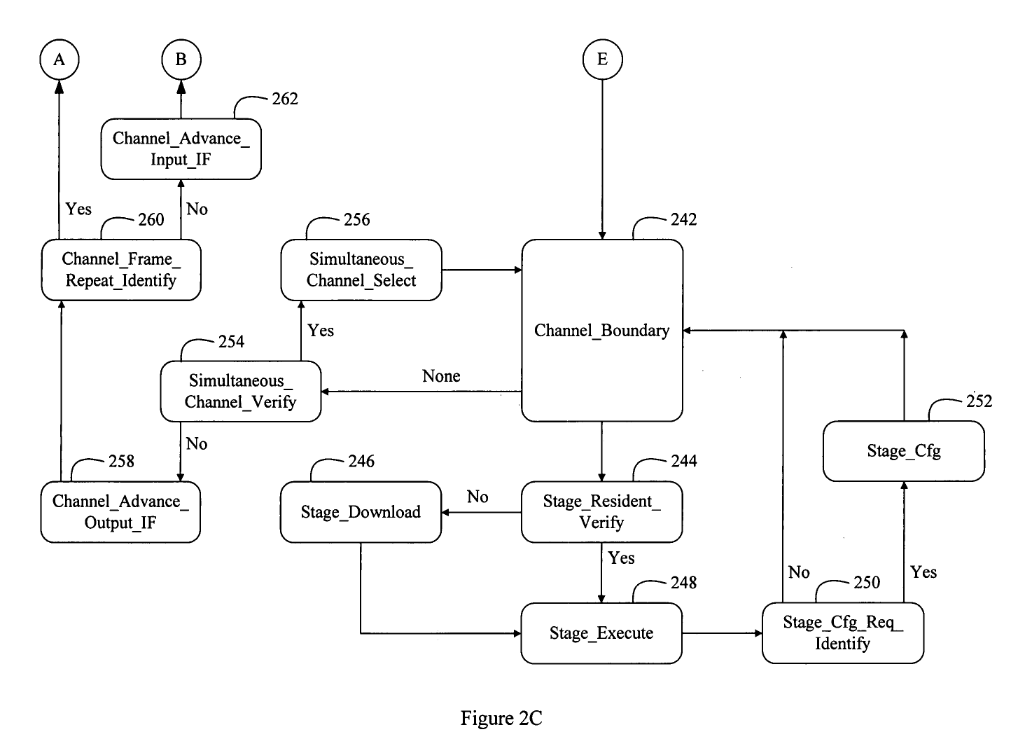

FIGS. 2A-2C show a flow diagram of an exemplary state machine 200 (or method) for decoding data utilizing dynamic code reconfiguration, in accordance with various aspects of the present invention. Various aspects of the exemplary state machine 200 may share characteristics of the method 100 shown in FIG. 1 and discussed previously. However, the scope of various aspects of the present invention should not be limited by notions of commonality between the exemplary methods 100, 200.

The state machine 200 may, for example, be implemented in a scheduler (e.g., hardware, software or hybrid). The following discussion will generally refer to the entity operating according to the state machine 200 as a “scheduler,” but this should by no means limit the scope of various aspects of the present invention to characteristics of a particular entity that may operate in accordance with the exemplary state machine 200.

The state machine 200 may comprise a frame boundary state 202. The frame boundary state 202 may comprise checking for synchronous communications with another entity (e.g., a host processor). In an exemplary scenario, a host processor may provide synchronous configuration update information to the scheduler at a data frame boundary.

The state machine 200 may comprise an error recovery state 204. The error recovery state 204 may, for example, comprise handling error processing, reporting status and/or interrupting the host. The error recovery state 204, when complete, may transition to the frame boundary state 202 (e.g., through the status_update state 264 discussed later).

The state machine 200 may comprise a sync_input state 206. In an exemplary scenario, if the host needs to configure the DSP (or processor executing the scheduler), the host may alert the DSP after the host has updated the configuration input. The DSP may then, for example, update its active configuration and indicate to the host that the new configuration has been accepted.

The state machine 200 may comprise a sync_output state 208. In an exemplary scenario, the DSP may provide status to the host after processing a data frame (e.g., an audio data frame). The DSP may, for example, update status output values and then signal the host that new status information is available.

The state machine 200 may comprise a channel_sink_verify state 210. In the channel_sink_verify state 210, the scheduler may, for example, check output buffer(s) for space to store a processed data frame. If there is no space available in the output buffer(s), the scheduler may cycle through the status_update state 264, to report the status to the host, and transition back to the frame_boundary state 202. The scheduler may, for example, cycle through the loop including the frame_boundary state 202, the channel_sink_verify state 210, and the status_update state 264 until the scheduler detects that an output buffer(s) has room to store an output frame (e.g., a processed audio frame). When, at the channel_sink_verify state 210, the scheduler determines that there is space available in an output buffer(s) for an output data frame, the scheduler may enter the channel_priority_identify state 212.

In the channel_priority_identify state 212, the scheduler may determine the priority for all channels that are ready to execute based on a selected algorithm. Then scheduler may, for example, determine channel priority in real-time. For example and without limitation, priority may be determined for each channel ready for processing based on the current system conditions of buffer levels, stream rates, processing requirements, etc. A selected algorithm may, for example, comprise aspects of rate monotonic scheduling (scheduling the short task first), earliest deadline first scheduling, first come first serve scheduling, etc.

The exemplary scheduler may exit the channel_priority_identify state 212 and enter the preliminary_channel_source_verify state 214. In the preliminary_channel_source_verify state 214, the scheduler may analyze enabled channels to determine if there is potentially at least one frame of compressed input data available for processing. Note that the preliminary_channel_source_verify state 214 may, for example, not determine if a data frame is definitely available for processing until acquiring frame sync, which will be discussed later.

If the scheduler, in the preliminary_channel_source_verify state 214 determines that there is not enough data present for a complete data frame to process (e.g., a complete audio data frame), the scheduler may enter a waiting loop created by the status_update state 264, frame_boundary state 202, channel_sink_verify state 210, channel_priority_identify state 212, and the preliminary_channel_source_verify state 214. If the scheduler, in the preliminary_channel_source_verify state 214, determines that there is at least enough data present for a frame of encoded data to process, the scheduler may enter the preliminary_channel_select state 216.

The scheduler may, for example, enter the preliminary_channel_select state 216 after verifying at the channel_sink_verify state 210 that there is enough space in an output buffer to store processed data, identifying priority for the channels at the channel_priority_identify state 212, and determining that there is compressed input data available for processing at the preliminary_channel_source_verify state 214. In the preliminary_channel_select state 216, the scheduler may select the highest priority enabled channel for processing based on information known at this point in the state machine 200. If various highest-priority channels are equal, a round-robin channel selection algorithm may be utilized. From the preliminary_channel_select state 216, the scheduler may enter the frame_sync_required_identify state 218.

In the frame_sync_required_identify state 218, the scheduler may determine for the selected channel if frame sync processing is required (e.g., to locate the input data frame in the input buffer). If frame sync is not necessary, the scheduler may transition to the channel_source_verify state 226. If frame sync processing is required, the scheduler may transition to the frame_sync_resident_identify state 220.

In the frame_sync_resident_identify state 220, the scheduler may determine if the required frame sync code is resident in local instruction memory. If the frame sync code is already loaded in the instruction memory, the scheduler may transition to the frame_sync_execute state 224.

If the frame sync code is not loaded in instruction memory, the scheduler may initiate a transfer of the frame sync executable to local instruction memory by entering the frame_sync_download state 222. In an exemplary scenario, the scheduler, in the frame_sync_download state 222 may initiate a DMA transaction to download the frame sync executable from external SDRAM into local instruction memory for a DSP to execute.

The scheduler may enter the frame_sync_execute state 224 when the frame_sync_required_identify state 218 determines that frame sync processing is required, and the scheduler has obtained a frame sync executable. The scheduler, in the frame_sync_execute state 224 may execute the frame sync executable. The scheduler may, for example, load and analyze one portion of an input buffer data at a time (e.g., DMA and analyze one index table buffer (ITB) entry at a time) until frame sync is achieved, all input data are exhausted, or a timeout count is reached. The scheduler may then transition to the channel_source_verify state 226.

In the channel_source_verify state 226, the scheduler may determine if there is actually valid input data available for processing. If there is no valid data available for processing, the scheduler may enter the channel_source_discard state 228. If there is valid data available for processing, the scheduler may transition to the channel_cfg_req_identify state 230.

In the channel_source_discard state 228, the scheduler may, for example, discard or empty data from selected channel input buffers that have been identified as containing invalid data. The scheduler may then transition back to the channel_sink_verify state 210 to restart operation back at the analysis of output buffer state.

In the channel_cfg_req_identify state 230, the scheduler may identify if channel configuration updating is necessary. If such a channel configuration update is required, the scheduler may transition to the channel_cfg_state 232, which updates channel configuration and transitions to the channel_time_verify state 234. If such a channel configuration update is not required, the scheduler may transition directly to the channel_time_verify state 234.

In the channel_time_verify state 234, the scheduler may, for example, analyze data stream timing information (e.g., by comparing such timing to the current system timing) to determine if the current data frame (e.g., an audio data frame) should be processed, dropped or delayed. In an exemplary scenario, if the scheduler determines that the current frame of data (e.g., an audio data frame) is outside a valid timing range, the scheduler may decide to drop the current data frame by entering the channel_source_frame_discard state 238, which discards the current input frame and jumps back to the channel_sink_verify state 210.

Continuing the exemplary scenario, if the scheduler determines that the current frame of data is within the valid timing range but too far in the future, the scheduler may delay processing the current frame by entering the threshold_verify stage 236. Such delay operation may, for example, be utilized in various scenarios where signal-processing timing may be significant (e.g., in a situation including synchronized audio and video processing).

The scheduler, in the threshold_verify state 236 may, for example, determine the extent of a processing delay for the current frame. In an exemplary scenario where such a processing delay is relatively small (e.g., a portion of a data frame duration), the scheduler may wait in a timing loop formed by the threshold_verify state 236 and the channel_time_verify state 234 until the timing requirements are met for processing the current frame. Alternatively, for example, in an exemplary scenario where such a processing delay is relatively large, the scheduler may jump back to the channel_sink_verify state 210.

Continuing the exemplary scenario, if the scheduler determines that the timing requirements for processing the current data frame are met, the scheduler may transition to the channel_select state 240, at which state the scheduler may proceed with processing the current data frame for the current channel.

From the channel_select state 240, the scheduler may enter the channel_boundary state 242. At this point, in an exemplary scenario, the scheduler may process the data frame (e.g., performing all enabled stages of processing sequentially) without interruption. According to the present example, processing stages may comprise parsing, decoding and post-processing stages.

From the channel_boundary state 242, the scheduler may enter the stage_resident_verify state 244. In the stage_resident_verify state 244, the scheduler may determine if software corresponding to the current processing stage is resident in the internal memory or must be loaded into the internal memory from external memory. If the code for the current stage is not resident in internal memory, the scheduler may enter the stage_download state 246, which downloads the processing stage executable into local instruction memory and transitions to the stage_execute state 248. If the code for the current stage is already resident in internal memory, the scheduler may enter the stage_execute state 248 directly.

In the stage_execute state 248, the scheduler (e.g., a DSP executing the scheduler software) may execute the processing stage code to process the current data frame. The scheduler may then enter the stage_cfg_req_identify state 250. In the stage_cfg_req_identify state 250, the scheduler may determine if a stage configuration update is required (e.g., based on the processing stage just executed). If a stage configuration update is required, the scheduler may transition to the stage_cfg state 252 to perform such an update. After performing a stage configuration update or determining that such an update is not necessary, the scheduler may transition back to the channel_boundary state 242.

Back in the channel_boundary state 242, the scheduler may, for example, determine that, due to a change in stage configuration (e.g., updated at the stage_cfg state 252), an additional stage of processing for the current data frame is necessary. The scheduler may then transition back into the stage_resident_verify state 244 to begin performing the next stage of processing.

The scheduler may also transition from the channel_boundary state 242 to the simultaneous_channel_verify state 254. The scheduler, in the simultaneous_channel_verify state 254, may determine if simultaneous processing is enabled and ready. As discussed previously with regard to the method 100 illustrated in FIG. 1, simultaneous mode may result in multiple processes being performed on the same input data frame. For example, the scheduler may perform a parsing processing task on the current data frame, resulting in a first output, and may also perform a decoding processing task on the current data frame, resulting in a second output. If the scheduler is currently performing simultaneous mode processing, such processing should occur on the current data frame before retrieving the next data frame. If the scheduler determines that simultaneous processing is to be performed, the scheduler may transition to the simultaneous_channel_select state 256. If the scheduler determines that simultaneous processing is not to be performed, the scheduler may transition to the channel_advance_output_IF state 258.

In the simultaneous_channel_select state 256, the scheduler may perform initialization and configuration tasks associated with processing the simultaneous channel. The scheduler may then transition back to the channel_boundary state 242 to continue with the simultaneous processing.

In the channel_advance_output_IF state 258, the scheduler may update output buffer parameters of the current channel (and for the simultaneous channel if required) to indicate that a new output frame of data is available. The scheduler may then, for example, transition to the channel_frame_repeat_identify state 260.

In the channel_frame_repeat_identify state 260, the scheduler may, for example, analyze processing status to determine if the current input data frame (e.g., a frame of audio data) should be repeated. Such a repeat may, for example and without limitation, be utilized to fill gaps in output data. If the scheduler determines that the current input data frame should not be repeated, the scheduler may transition to the channel_advance_input_IF state 262, in which the scheduler may, for example, update input buffer parameters of the current channel to indicate that the input data frame has been processed, and buffer space is available for re-use.

Following the channel_frame_repeat identify state 260 or the channel_advance_input_IF state 262, the scheduler may transition to the status_update state 264. The scheduler, in the status_update state 264, may update output status with the results of the data frame processing just performed. The scheduler may then, for example, transition back to the original frame_boundary state for continued processing of additional data.

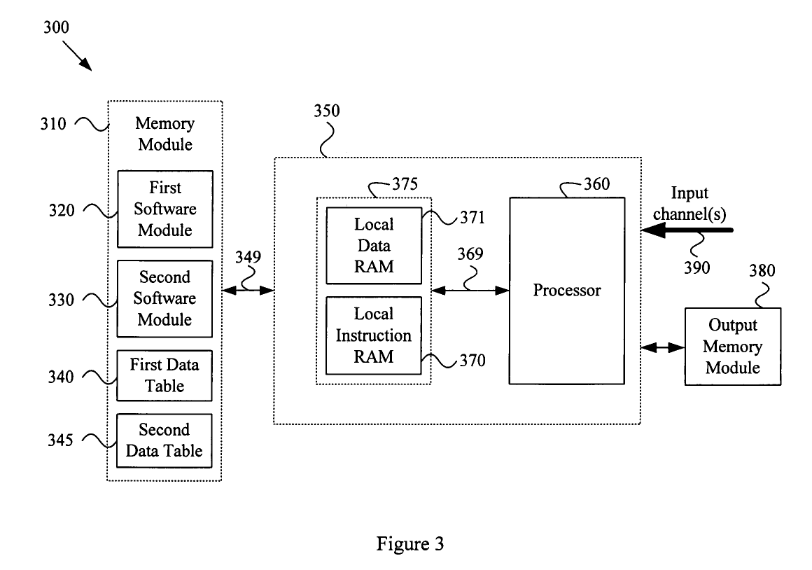

FIG. 3 is a diagram showing an exemplary system 300 for decoding data utilizing dynamic code reconfiguration, in accordance with various aspects of the present invention. The exemplary system 300 may comprise a first memory module 310 and a signal-processing module 350. The signal-processing module 350 may be communicatively coupled to the first memory module through a communication link 349. The communication link 349 may comprise characteristics of any of a large variety of communication link types. For example, the communication link 349 may comprise characteristics of a high-speed data bus capable of supporting direct memory access. The scope of various aspects of the present invention should not be limited by characteristics of a particular communication link type.

The exemplary system 300 may comprise an output memory module 380 that is communicatively coupled to the signal-processing module 350. The system 300 may further comprise one or more input channels 390 through which encoded data information may be received from external sources.

The first memory module 310 may comprise a first software module 320 and a second software module 330. The first and second software modules 320, 330 may, for example, comprise software instructions to perform a respective processing task. For example and without limitation, the first software module 320 may comprise software instructions to perform parsing of an input data frame (e.g., a frame of encoded/compressed audio data), and the second software module 320 may comprise software instructions to perform decoding of an input data frame.

Additionally, for example, the first memory module 310 may comprise a plurality of software modules that correspond to respective stages of a particular processing task. For example, one software module may be utilized to perform a first stage of a particular processing task, and another software module may be utilized to perform a second stage of the particular processing task. Further, the first memory module 310 may also comprise a plurality of data tables 340, 345, which may be utilized with the various software modules.

The first memory module 310 may, for example, comprise any of a large variety of memory types. For example and without limitation, the first memory module 310 may comprise DRAM or SDRAM. In an exemplary scenario, the first memory module 310 and the signal-processing module 350 may be located on separate integrated circuit chips. Note, however, that the scope of various aspects of the present invention should not be limited by characteristics of particular memory types or a particular level of component integration.

The signal-processing module 350 may comprise a local memory module 375 and a local processor 360. The local processor 360 may be communicatively coupled to the local memory module 375 through a second communication link 369. The second communication link 369 may comprise characteristics of any of a large variety of communication link types. For example, the communication link 369 may provide the local processor 360 one-clock-cycle access to data (e.g., instruction data) stored in the local memory module 375. Note, however, that the scope of various aspects of the present invention should not be limited by characteristics of a particular communication link type.

The local memory module 375 may, for example, comprise a memory module that is integrated in the same integrated circuit as the local processor 360. For example and without limitation, the local memory module 375 may comprise on-chip SRAM that is coupled to the local processor 360 by a high-speed bus. The local memory module 375 may also, for example, be sectioned into a local instruction RAM portion 370 and a local data RAM portion 371. Note, however, that the scope of various aspects of the present invention should not be limited by characteristics of a particular memory type, memory format, memory communication, or level of device integration.

The local processor 360 may comprise any of a large variety of processing circuits. For example and without limitation, the local processor 360 may comprise a digital signal processor (DSP), general-purpose microprocessor, general-purpose microcontroller, application-specific integrated circuit (ASIC), etc. Accordingly, the scope of various aspects of the present invention should in no way be limited by characteristics of a particular processing circuit.

The signal-processing module 350 may, for example, comprise one or more input channels(s) 390 through which the signal-processing module 350 may receive data to process. In an exemplary scenario where the signal processing module 350 processes encoded audio information, the signal-processing module 350 may receive a first data stream of AC3-encoded information over a first input channel and a second data stream of AAC-encoded information over a second input channel. The input channel(s) 390 may, for example, correspond to input buffers in memory. For example and without limitation, the input buffers may physically reside in the first memory module 310 or another memory module. Accordingly, the scope of various aspects of the present invention should not be limited by characteristics of a particular input channel implementation.

As mentioned previously, the system 300 may comprise an output memory module 380. The signal-processing module 350 may be communicatively coupled to the output memory module 380 and may output information resulting from signal processing operations (e.g., decoded audio data) to the output memory module 380. As discussed previously with regard to the first memory module 310 and the local memory module 375, the scope of various aspects of the present invention should not be limited by characteristics of a particular output memory module type, memory interface, or level of integration. Further, the output module 380, though illustrated as a separate module in FIG. 3, may comprise a portion of the first memory module 310, local memory module 375 and/or other memory.

The local processor 360 or other components of the exemplary system 300 may, for example, implement various aspects of the methods 100, 200 illustrated in FIGS. 1-2 and discussed previously. For example, on power-up or reset, the local processor 360 may load software instructions corresponding to aspects of the exemplary methods 100, 200 into the local memory module 375 and execute such software instructions to process data arriving over one or more input channels 390. Note, however, that the scope of various aspects of the present invention should not be limited by characteristics of such an implementation of the exemplary methods 100, 200.

Various events and conditions may cause the exemplary system 300 to begin processing (e.g., decoding encoded data). For example, an input signal may arrive at one or more of the input channels 390 for decoding. For example, in an exemplary audio decoding scenario, an encoded audio signal may arrive at the signal processor 350 or related system element for decoding. Generally, the system 300 may begin processing for a variety of reasons. Accordingly, the scope of various aspects of the present invention should not be limited by characteristics of particular initiating events or conditions.

During processing, the local processor 360 may determine whether there is space available in one or more output buffers (e.g., in the output memory module 380) for processed information. If the local processor 360 determines that there is no output buffer space, the local processor 360 may, for example, wait for output buffer space to become available. Output buffer space may become available, for example, by a downstream device reading data out from an output buffer. If the local processor 360 determines that there is output buffer space available for additional processed information, the local processor 360 may determine whether there is input data available for processing.

The local processor 360 may, for example, select a channel over which to receive data to decode (or otherwise process). In the exemplary scenario illustrated in FIG. 3, the local processor 360 may receive encoded data over any of a plurality of input channels 390. The local processor 360 may, for example, select between the plurality of input channels. Note that the plurality of input channels 390 may, for example, communicate information that is encoded by any of a variety of encoding types.

For example and without limitation, in selecting between a plurality of input channels, the local processor 360 may utilize a prioritized list of input channels to service. For example, the local processor 360 may read such a prioritized list from memory or may build such a prioritized list in real-time. The local processor 360 may, for example, cycle through a prioritized list until a channel is located that has a frame of data to decode.

Such a prioritized list may be determined based on a large variety of criteria. For example, a prioritized list may be based on availability of output buffer space in the output memory module 380 corresponding to a particular buffer. Also, for example, a prioritized list may be based on the availability of input data in an input buffer (or input channel 390). Further, for example, a prioritized list may be based on input data stream rate, the amount of processing required to process particular input data, first come first serve, earliest deadline first, etc. In general, channel priority may be based on any of a large variety of criteria, and accordingly, the scope of various aspects of the present invention should not be limited by characteristics of a particular type of channel prioritization or way of determining priority between various channels.

The local processor 360 may, for example, identify a data frame to decode. For example, in a multi-channel scenario such as that discussed previously, after selecting a particular input channel from the prioritized list, the local processor 360 may identify a data frame within the selected channel to decode. Such identification may, for example, comprise identifying a location in an input buffer at which the next data frame for a particular input channel resides. Such identification may also, for example, comprise determining various other aspects of the identified data frame (e.g., content data characteristics, starting point, ending point, length, etc.). In an exemplary audio signal decoding scenario, the local processor 360 may identify a next audio frame corresponding to the identified input channel.

The local processor 360 may, for example, select a processing task to perform on the identified data frame. For example, the local processor 360 may select a processing task from a plurality of processing tasks. The local processor 360 may, for example, select a processing task based on real-time analysis of information arriving on a selected input channel 390 or may, for example, select a processing task based on stored configuration information correlating a processing task with a particular input channel 390.

In an exemplary signal decoder scenario, a plurality of processing tasks may comprise a parsing processing task, a decoding processing task and/or a combined parsing and decoding processing task. The local processor 360, implementing an exemplary parsing processing task may parse the identified data frame (e.g., an encoded audio data frame) and output information of the parsed data frame to an output buffer in the output memory module 380. Such information of the parsed data frame may, for example, comprise the same compressed data with which the identified data frame arrived and may also comprise status information determined by the local processor 360 performing the parsing processing task. For example, the local processor 360, performing the parsing processing task, may output information of the parsed data frame in compressed PCM (or non-linear PCM) format.

The local processor 360, implementing an exemplary decoding processing task may decode the identified data frame (e.g., an encoded audio data frame) and output information of the decoded data frame to an output buffer in the output memory module 380. Such information of the decoded data frame may, for example, comprise decoded (or decompressed) data that corresponds to the encoded (or compressed) information with which the identified data frame arrived. For example, the local processor 360, performing the decoding processing task, may output information of the decoded data frame in uncompressed PCM (or linear PCM) format.

The decoding processing task is not necessarily limited to performing a standard decoding task. For example and without limitation, in an exemplary audio decoding scenario, the local processor 360, executing the decoding processing task, may perform MPEG layer 1, 2 or 3, AC3, or MPEG-2 AAC decoding with associated post-processing. The local processor 360 may, for example, also perform high fidelity sampling rate conversion, decoding LPCM, etc. Accordingly, the scope of various aspects of the present invention should not be limited by characteristics of a particular decoding processing task or sub-task, or by characteristics of other related processing tasks.

The local processor 360, implementing an exemplary combined parsing and decoding processing task may perform each of the parsing and decoding processing tasks discussed previously. For example and without limitation the local processor 360, executing the combined parsing and decoding processing task, may output information of the parsed data frame and information of the decoded data frame to one or more output buffers in the output memory module 380. For example, the local processor 360, executing the combined parsing and decoding processing task, may output information in both linear and non-linear PCM format. In an exemplary scenario, the local processor 360 may output information of the same data stream with the same PID in both linear PCM and non-linear PCM formats.

Note that the previously discussed exemplary scenario involving the local processor 360 implementing the simple, complex and simultaneous modes and associated processing tasks (as discussed previously) is merely exemplary. In general, the local processor 360 may select a processing task from a plurality of processing tasks. Accordingly, the scope of various aspects of the present invention should not be limited by characteristics of a particular processing task or group of processing tasks.

The local processor 360 may, for example, load software instructions and/or associated data corresponding to the selected processing task into local memory 375 (e.g., in local instruction RAM 370 of local memory 375). In an exemplary scenario, such software instructions may be initially stored in the first memory module 310. For example and without limitation, the local processor 360 may load such software instructions into local memory 375 by initiating a DMA transfer of such software instructions from the first memory module 310 to the local memory 375. The local processor 360 may, for example, utilize a look-up table to determine where software instructions corresponding to the selected processing task are located.

In general, the local processor 360 may load and/or initiate loading of software instructions corresponding to the selected processing task into the local memory 375. Accordingly, the scope of various aspects of the present invention should not be limited by characteristics of particular software, characteristics of particular software storage, or characteristics of a particular software loading process.

The local processor 360 may, for example, execute the software instructions loaded into the local memory 375. The local processor 360 may execute the loaded software instructions to partially or completely process all or a portion of the identified data frame.

As mentioned previously, the software instructions corresponding to the selected processing task may, for example, reside in independent software modules, which may be independently and sequentially loaded and executed. For example, a particular decoding task for a particular encoding style may comprise a series of software modules that may be loaded and executed sequentially to accomplish the selected processing task. For example and without limitation, a particular decoding processing task may comprise a main decoding software module and a post-processing software module.

Accordingly, the local processor 360 may determine whether there is additional software to execute to accomplish the selected processing task on the identified data frame. If the local processor 360 makes such a determination, then the local processor 360 may load (or initiate the loading of) the additional software into the local memory 375 and execute such loaded software to further process the identified data frame.

After or during processing the identified data frame, the local processor 360 may determine whether there is additional data to process. For example, the current input channel or other input channel may comprise additional data frames to process.

If the local processor 360 determines that there is additional data to process, the local processor 360 may, for example, first wait for adequate space in an output buffer of the output memory module 380 before processing additional data. If the local processor 360 determines that there is no additional data to process, the local processor 360 may, for example, stop processing input data or may continue to actively monitor output and input buffers to determine whether to process additional data.

It should be noted that the system 300 illustrated in FIG. 3 is exemplary. The scope of various aspects of the present invention should by no means be limited by particular details of specific illustrative components or connections therebetween.

In summary, aspects of the present invention provide a system and method for decoding data utilizing dynamic memory reconfiguration. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to any particular embodiment disclosed, but that the invention will include all embodiments falling within the scope of the appended claims.

What is claimed is:

1. In a signal decoder, a method for processing a data frame, the method comprising:
identifying a data frame;
selecting a processing task from a plurality of processing tasks comprising:
parsing the identified data frame; and
decoding the identified data frame;
loading software instructions corresponding to the selected processing task into a local memory module of a processor; and
executing the loaded software instructions with the processor to process the identified data frame.

2. The method of claim 1, wherein the plurality of processing tasks further comprises a processing task comprising combined parsing and decoding the identified data frame.

3. The method of claim 2, wherein combined parsing and decoding the identified data frame comprises:
parsing the identified data frame to produce first output information; and
decoding the identified data frame to produce second output information, wherein the first output information and the second output information are both output to output memory.

4. The method of claim 1, wherein identifying a data frame comprises selecting an input channel from a plurality of input channels.

5. The method of claim 4, wherein selecting an input channel comprises determining a prioritized list of input channels, and utilizing the prioritized list to select the input channel from the plurality of input channels.

6. The method of claim 1, wherein the identified data frame comprises encoded audio information.

7. The method of claim 1, further comprising, after executing at least a portion of the loaded software instructions with the processor to process the identified data frame, loading second software instructions into the local memory module of the processor, and executing the loaded second software instructions with the processor to further process the identified data frame.

8. In a signal decoder, a method for processing data, the method comprising:
selecting an input channel from a plurality of input channels;
identifying a data frame corresponding to the selected input channel;
selecting a processing task from a plurality of processing tasks;
loading software instructions corresponding to the selected processing task into a local memory module of a processor; and
executing the loaded software instructions with the processor to process the identified data frame.

9. The method of claim 8, further comprising:
selecting a second input channel from the plurality of input channels;
identifying a second data frame corresponding to the selected second input channel;
selecting a second processing task from the plurality of processing tasks;
loading second software instructions corresponding to the selected second processing task into the local memory module of the processor; and
executing the loaded second software instructions with the processor to process the identified second data frame.

10. The method of claim 8, wherein selecting an input channel comprises determining a prioritized list of input channels, and selecting the input channel based at least in part on the prioritized list of input channels.

11. The method of claim 8, wherein the identified data frame comprises encoded audio information.

12. The method of claim 8, wherein the plurality of processing tasks comprises:
parsing the identified data frame; and
decoding the identified data frame.

13. The method of claim 12, wherein the plurality of processing tasks comprises a processing task comprising combined parsing and decoding the identified data frame, wherein combined parsing and decoding the identified data frame comprises:
parsing the identified data frame to produce first output information; and
decoding the identified data frame to produce second output information, wherein the first output information and the second output information are both output to output memory.

14. The method of claim 8, further comprising, after executing at least a portion of the loaded software instructions with the processor to process the identified data frame, loading second software instructions into the local memory module of the processor, and executing the loaded second software instructions with the processor to further process the identified data frame.

15. A signal decoder comprising:
a first input channel;
a first memory module comprising respective software modules corresponding to each of a plurality of processing tasks, wherein the plurality of processing tasks comprises:
parsing an identified data frame; and
decoding an identified data frame; and
a signal processing module, communicatively coupled to the first input channel and the first memory module, wherein the signal-processing module comprises:
a local memory module; and
a local processor, communicatively coupled to the local memory module, wherein the local processor:
identifies a data frame corresponding to the first input channel;
selects a processing task from the plurality of processing tasks;
loads the respective software module corresponding to the selected processing task into the local memory module; and
executes the loaded software module to process the identified data frame.

16. The signal decoder of claim 15, wherein the plurality of processing tasks further comprises a processing task comprising combined parsing and decoding the identified data frame.

17. The signal decoder claim 16, further comprising an output memory module communicatively coupled to the signal processing module, and wherein combined parsing and decoding the identified data frame comprises:
parsing the identified data frame to produce first output information; and
decoding the identified data frame to produce second output information, wherein the signal-processing module outputs the first output information and the second output information to the output memory module.

18. The signal decoder of claim 15, wherein the signal decoder comprises a plurality of input channels, and wherein the local processor further selects the first input channel from the plurality of input channels.

19. The signal decoder of claim 18, wherein the local processor determines a prioritized list of input channels, selects the first input channel from the plurality of input channels based at least in part on the prioritized list.

20. The signal decoder of claim 15, wherein the identified data frame comprises encoded audio information.

21. The signal decoder of claim 15, wherein the local processor, after executing at least a portion of the loaded software module to process the identified data frame, loads a respective second software module into the local memory module, and executes the loaded second software module to further process the identified data frame.

22. The signal decoder of claim 15, wherein the local memory module and the local processor are integrated into a single integrated circuit.

23. A signal decoder comprising:
a plurality of input channels;
a first memory module comprising respective software modules corresponding to each of a plurality of processing tasks; and
a signal processing module, communicatively coupled to the plurality of input channels and the first memory module, wherein the signal processing module comprises:
a local memory module; and
a local processor, communicatively coupled to the local memory module, wherein the local processor:
selects an input channel from the plurality of input channels;
identifies a data frame corresponding to the selected input channel;
selects a processing task from the plurality of processing tasks;
loads a software module corresponding to the selected processing task into the local memory module; and
executes the loaded software module to process the identified data frame.

24. The signal decoder of claim 23, wherein the local processor further:
selects a second input channel from the plurality of input channels;
identifies a second data frame corresponding to the selected second input channel;
selects a second processing task from the plurality of processing tasks;
loads a second software module corresponding to the selected second processing task into the local memory module; and
executes the loaded second software module to process the identified second data frame.

25. The signal decoder of claim 23, wherein the local processor selects an input channel from the plurality of input channels by determining a prioritized list of input channels, and selecting the input channel based at least in part on the prioritized list of input channels.

26. The signal decoder of claim 23, wherein the identified data frame comprises encoded audio information.

27. The signal decoder of claim 23, wherein the plurality of processing tasks comprises:
parsing the identified data frame; and
decoding the identified data frame.

28. The signal decoder of claim 27, further comprising an output memory module communicatively coupled to the signal processing module, wherein the plurality of processing tasks comprises a processing task comprising combined parsing and decoding the identified data frame, wherein combined parsing and decoding the identified data frame comprises:
parsing the identified data frame to produce first output information; and
decoding the identified data frame to produce second output information, wherein the signal-processing module outputs the first output information and the second output information to the output memory module.

29. The signal decoder of claim 23, wherein the local processor, after executing at least a portion of the loaded software module to process the identified data frame, loads a respective second software module into the local memory module, and executes the loaded second software module to further process the identified data frame.

30. The signal decoder of claim 23, wherein the local memory module and the local processor are integrated into a single integrated circuit.
